(19) United States
(12) Patent Application Publication
(10) Pub. No.: US 2017/0334284 A1
(43) Pub. Date: Nov. 23, 2017

(54) ACTIVE GRILL SHADE

(71) Applicant: FORD GLOBAL TECHNOLOGIES, LLC, Dearborn, MI (US)

(72) Inventors: James Adam Drozdowski, Canton, MI (US); Charlie Qian, Dearborn, MI (US); Jay Robert Degenkolb, Rockwood, MI (US)

(21) Appl. No.: 15/157,104

(22) Filed: May 17, 2016

(51) Int. Cl. B60K 11/08; B60R 19/52

(52) U.S. Cl. CPC B60K 11/085; B60R 19/52

(57) ABSTRACT

A grille shade assembly for a vehicle includes a deployable flexible grille shade and one or more drive elements for translating the flexible grille shade between a deployed and a stowed position. A motor is operatively connected to the one or more drive elements. A carrier carrying the deployable flexible grille shade is operatively connected to the one or more drive elements. One or more trolley slides engage a portion of the flexible grille shade and the one or more drive elements to effect translation of the grille shade between the deployed and retracted position. A controller is operatively connected to the motor and to one or more sensors.

### TECHNICAL FIELD

This disclosure relates generally to airflow control for motor vehicles. In particular, the disclosure relates to a deployable shade for altering exterior airflow supply to a vehicle engine compartment.

### BACKGROUND

Airflow provided to a vehicle engine and/or cooling module as the vehicle is operated provides an effective and convenient means for engine cooling at lower speeds. However, as the speed at which a motor vehicle travels increases, airflow into the vehicle engine compartment may increase vehicle drag and therefore decrease fuel economy. To compensate for this, systems such as Active Grille Shutters (AGS) have been utilized. As is known, AGS typically comprise a series of pivoting shutter-style louvers attached to a vehicle body structure in front of the vehicle engine cooling module. These louvers may be oriented to allow maximum airflow through a grille opening and into the engine compartment to promote cooling as the vehicle is operated at low speeds, but which may be fully or partially closed at higher speeds to block airflow through the grille opening/into the engine compartment to reduce aerodynamic drag. At such higher speeds, reduced airflow into the engine compartment is adequate to provide the desired engine cooling function.

While effective, in conventional systems the AGS louvers are held in a substantially horizontal orientation when fully open and therefore increased packaging space is required to implement AGS in a vehicle. Moreover, the louvers and attendant actuation mechanisms add significant weight, potentially degrading vehicle fuel efficiency.

To solve this and other problems, the present disclosure relates to an active grille shade assembly for a vehicle, configured for vertical translation between a fully stowed and a fully deployed position. Because the active grille shade deploys and retracts vertically rather than rotating between a horizontal and a vertical orientation, less packaging space is required in the vehicle x-axis direction. Moreover, the described assembly provides significant weight savings compared to existing AGS systems, further improving fuel efficiency.

### SUMMARY

In accordance with the purposes and benefits described herein, in one aspect of the disclosure an active grille shade assembly for a vehicle is described, comprising a deployable flexible grille shade and one or more drive elements for translating the flexible grille shade between a deployed and a stowed position. A motor is operatively connected to the one or more drive elements.

In embodiments, a carrier carrying the deployable flexible grille shade is operatively connected to the one or more drive elements. One or more support struts for supporting the flexible grille shade when translated to the deployed position may be included. In embodiments, the one or more support struts are substantially vertically oriented.

One or more trolley slides configured for engaging a portion of the flexible grille shade and the one or more drive elements may be provided to effect translation of the grille shade between the deployed and retracted position. A lower drive shaft is included for engaging the one or more drive elements.

In embodiments, the assembly is carried by an upper frame rail, a lower frame rail, and a pair of opposed side rails. The pair of opposed side rails may be configured to slidingly receive at least a portion of the one or more drive elements, the one or more trolley slides, and the lower drive shaft in an interior channel thereof, thus reducing packaging space required for the assembly.

A controller is operatively connected to the motor and to one or more sensors. In embodiments, the one or more sensors are from one or more of an engine temperature sensor, a coolant temperature sensor, a vehicle-exterior ambient temperature sensor, a cooling module temperature sensor, and a vehicle speed sensor.

In the following description, there are shown and described embodiments of the disclosed active grille shade assembly. As it should be realized, the devices and systems are capable of other, different embodiments and their several details are capable of modification in various, obvious aspects all without departing from the devices as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed active grille shade assembly, and together with the description serve to explain certain principles thereof. In the drawings:

FIG. 1 shows a vehicle including an active grille shade assembly according to the present disclosure;

FIG. 2 shows an exploded view of the active grille shade assembly of FIG. 1;

FIG. 3 shows an isolated view of a trolley slide engaging a drive belt;

FIG. 4 shows an isolated view of a grille shade rod engaging the trolley slide of FIG. 3;

FIG. 5 schematically shows a representative control mechanism for the active grille shade assembly of FIG. 1; and

FIG. 6 shows in flow chart form representative logic for control of the active grille shade assembly of FIG. 1.

Reference will now be made in detail to embodiments of the disclosed active grille shade assembly, examples of which are illustrated in the accompanying drawing figures.

### DETAILED DESCRIPTION

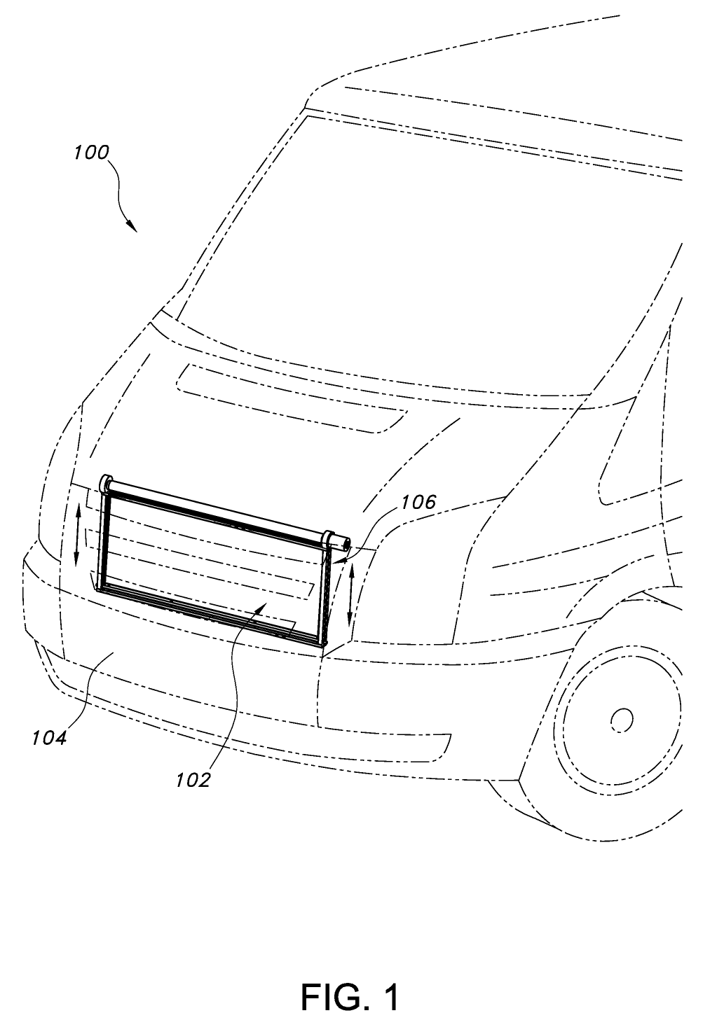

With reference to FIG. 1, there is shown a vehicle 100 equipped with an active grille shade assembly 102 according to the present disclosure. The active grille shade assembly 102 is attached to the vehicle 100 behind a vehicle fascia 104 and grille opening 106. By mechanisms which will be described in detail below, the active grille shade assembly 102 is configured for vertical translation (see arrows) between a fully stowed and a fully deployed position as shown in the drawing. When fully or partially deployed, the active grille shade assembly reduces airflow from an exterior of the vehicle 100 into the engine compartment 107, reducing drag and thereby improving fuel economy.

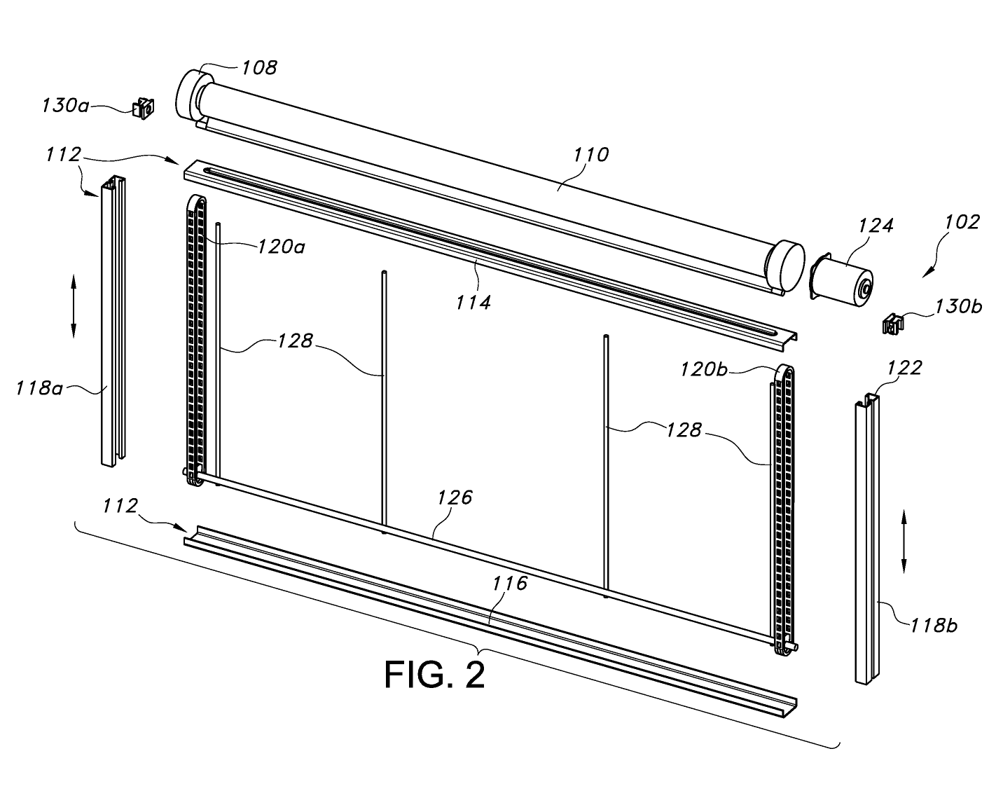

The active grille shade assembly 102 is shown in detail in FIG. 2. In the depicted embodiment, the active grille shade assembly 102 comprises a roll-up type grille shade including a carrier 108, in the depicted embodiment being a roller comprising side bearings and a guide shaft, on which the grille shade 110 is spooled for deployment and retraction. A frame assembly 112 carries the active grille shade assembly 102 and also attaches the grille shade assembly to a vehicle by one or more brackets (not shown), such as behind the vehicle front fascia 104/grill opening 106 as shown in FIG. 1. As shown, the frame assembly 112 includes a top frame member 114, a bottom frame member 116, and opposed side frame members 118a, 118b. As depicted, the carrier 108 is attached to the top frame member 114.

The top frame member 114 may include a slot (not visible in this view) through which the grille shade 110 passes. Optionally, the grille shade 110 slot may include an integral or attached cleaning element for cleaning the grille shade 110 during deployment and/or retraction to remove insects, dust, mud, debris, etc. that may have accumulated on the shade during vehicle operation. In an embodiment, the cleaning element is provided by one or more brushes disposed adjacent to the grille shade slot 110 and extending all or a portion of a width dimension of the slot.

The active grille shade assembly 102 further includes one or more drive elements for translating the grille shade 110 vertically between the fully retracted and fully deployed positions. In the depicted embodiments, a pair of drive elements 120a, 120b are provided, at least a portion of each of which is received in an extrusion or internal channel 122 defined in the opposed side frame members 118a, 118b. As will be appreciated, this reduces packaging space required for the active grille shade assembly 102. The drive elements 120a, 120b may in various embodiments be composite belts, chains, or other suitable elements.

In the depicted embodiment, the drive elements 120a, 120b are rotatably carried at a first end by a portion of the carrier 108, whereby rotation of the carrier causes the drive elements to move. A motor assembly 124 is operatively connected to the carrier 108 whereby operation of the motor rotates the carrier to deploy or retract the grille shade 110 as will be described. In alternative embodiments, the motor 124 may be directly operatively connected to gearing (not shown) driving the drive elements 120a, 120b.

As depicted, a motor 124 is provided selectively allowing clockwise and counter-clockwise rotation of the carrier to deploy or retract the grille shade 110. In embodiments, the motor may be a stepper motor of known design which rotates the carrier 108 and/or the drive elements 120a, 120b over a finite number of positions or degree increments, or may not include such restrictions on the degree through which the motor will rotate the carrier. The motor 124 may include a grille shade 110 position sensor (not shown) for determining a position of the grille shade, i.e. fully retracted, fully deployed, or at one or more intermediate positions.

The drive elements 120a, 120b are rotatably carried at a second, opposed end by a drive shaft 126, a portion of opposed ends of which include bearings (not shown) and are received in/attached to the opposed side frame member internal channels 122. One or more support struts 128, in the depicted embodiment being substantially vertically oriented rods, are provided attached at a first end to the upper frame member 114 and at a second, opposed end to the lower frame member 116. As will be appreciated, the support struts 128 provide support to the flexible grille shade 110 when in the partially or fully deployed position.

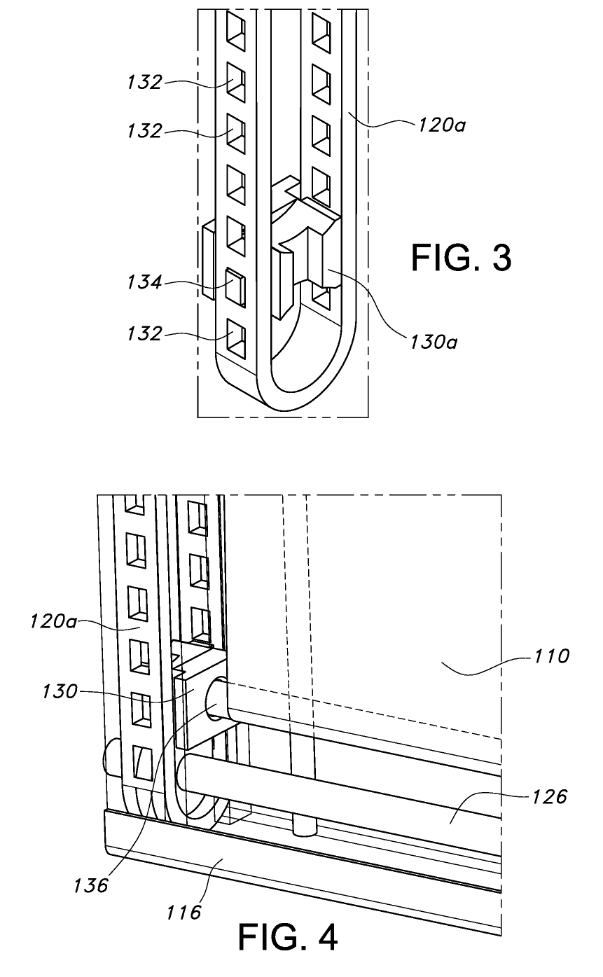

The active grille shade assembly 102 further includes at least one trolley slide 130, configured for engaging spaced apertures 132 in the drive elements 120a, 120b such as by friction fit pins 134 (see FIG. 3). In the depicted embodiment, a pair of trolley slides 130a, 130b are provided. A rod 136 attached to a bottom edge of the grille shade 110 is captured at opposed ends by the trolley slides 130 as shown in FIG. 4. As will be appreciated, as the carrier 108 rotates and the drive elements 120a, 120b translate vertically as described above, the trolley slides 130a, 130b are translated vertically along with the drive belt movement to raise and/or lower the grille shade 110 by way of captured rod 126.

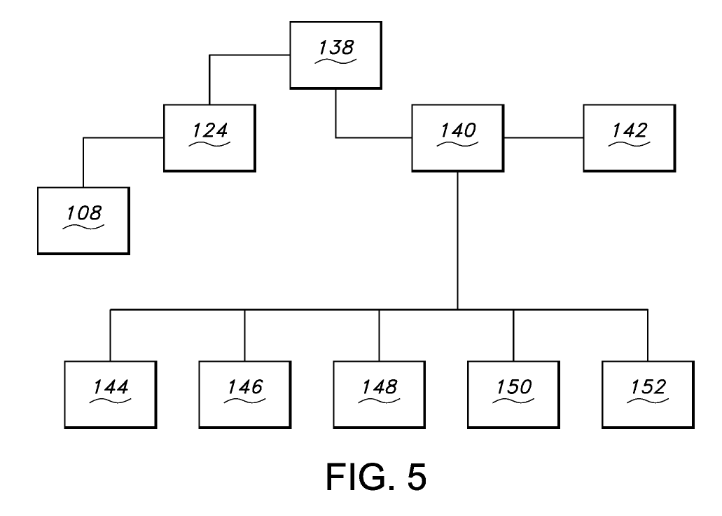

The active grille shade assembly 102 may be operatively connected to a variety of sensors and vehicle controllers and control modules. By way of non-limiting example, FIG. 5 depicts a representative control system for the active grille shade assembly 102 of the present disclosure. As shown therein, the motor 124 may include or be otherwise operatively associated with a central processing unit (“CPU”) or other controller 138 having its own logic and control software. Input from a vehicle control module 140 directs the motor 124 regarding which direction and how far to rotate thereby controlling movement of the carrier 108 and drive elements 120a, 120b. For example, the control module 140 may command the motor 124 via controller 138 to rotate the carrier 108 sufficiently to fully or partially deploy the grille shade 110, or to fully or partially retract the grille shade. Thus, airflow into the engine compartment 107 may be regulated in any number of incremental degrees between full airflow and no airflow. As will be appreciated, the control module 140 and controller 138 may be pre-programmed to provide any number of incremental degrees of airflow between a fully retracted grille shade 110 and a fully deployed grille shade.

In an embodiment, the control module 140 may be the vehicle's powertrain control module (“PCM”), which may communicate directly with the motor 124. Alternatively, the control module 140 may communicate with the motor 124 indirectly via a second or third control module communicating with the control module 140 via a vehicle controller area network (CAN), for example, a LIN bus. In the embodiment shown in FIG. 5, the control module 140 communicates with other vehicle control modules via a LIN bus 142. Even more, the control module 140 could be a designated active grille shutter system 102 control module, or another control module in the vehicle, in communication with the control module 140 or other control modules via the LIN bus 142.

The active grille shade system 102 may further include one or more sensors which provide inputs to the control module 140. As examples, the control module 140 may be in direct or indirect communication with a sensor array including one or more of an engine temperature sensor 144, a coolant temperature sensor 146, a cooling module temperature sensor 148, a vehicle-exterior ambient temperature sensor 150, and a vehicle speed sensor 152. As will be appreciated, the sensors provide input relating to temperature and/or vehicle speed, which the control module interprets to select a predetermined grille shade 110 deployment position. This can be accomplished by any number of methods, for example by a simple lookup table stored in the control module 140 or controller 138 memory.

The lookup table may include various temperatures or ranges of temperature for vehicle engine components, and various vehicle speeds or ranges of speeds. Thus, as non-limiting examples, at speeds below 15 mph and/or ambient temperatures of 96° F. or more, the control module 140 may cause the grille shade 110 to fully retract, whereas at speeds of 45 mph or more and/or ambient temperatures of 32° F. or less, the control module 140 may cause the grille shade 110 to fully deploy. Likewise, if the cooling module temperature sensor 148 indicates a temperature of 212° F. or more, the control module 140 may cause the grille shade 110 to fully retract to maximize cooling airflow to the engine compartment 107. Again, as discussed above any number of intermediate deployment positions, all tied to particular vehicle component and/or ambient temperatures and vehicle speeds, are contemplated. Moreover, the skilled artisan will readily appreciate that the above speed and temperature values are representative only, and that particular control module 140 settings may be implemented according to vehicle configuration, intended vehicle use and use conditions, etc.

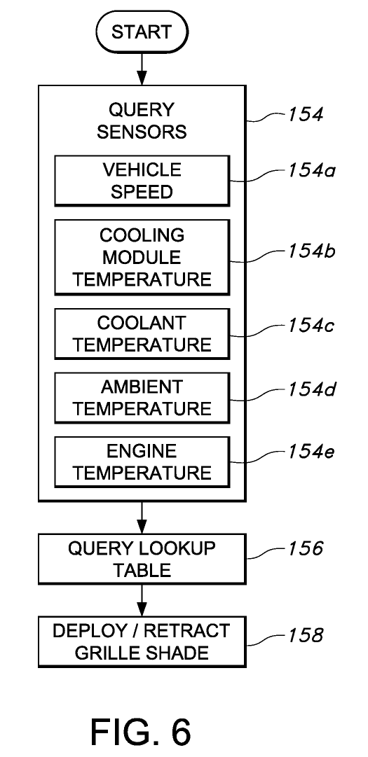

FIG. 6 illustrates an embodiment of control logic for controlling operation of the active grille shade assembly 102. As shown therein, in the depicted embodiment operation of the active grille shade assembly 102 is tied to one or more of ambient temperature, vehicle cooling module temperature, and vehicle speed. At step 154, the control module 140 queries and receives inputs from one or more vehicle sensors 144, . . . , 152 as described above (steps 154a, 0154b, 154c, . . . 154e. By way of a lookup table (step 156), the determined vehicle speed, cooling module temperature, and ambient temperature are compared and a specific degree of required grille shade 110 deployment is determined. At step 158, the control module 140 issues a command to the motor 124 to rotate the carrier 108 clockwise or counterclockwise in accordance with whether the grille shade 110 is to be deployed or retracted and to what degree, and the grille shade is positioned accordingly to allow the desired amount of airflow and thereby cooling into the engine compartment 107.

Thus, by the above-described structures and mechanisms, a similar functionality is provided as that of an AGS system, that is, aerodynamic closure of open engine cooling module cores (radiator, A/C condenser, and other coolers). By the described active grille shade assembly 102, exterior airflow to the engine compartment 107 can be restricted, for example at higher vehicle speeds and/or when situations imposing reduced engine cooling requirements are encountered. The system is simple, robust, and efficient, and provides a significant weight savings over traditional AGS systems.

Still more, an added functionality of the assembly 102 is that the grille shade 110 may be deployed as needed in cold weather even if vehicle speed and cooling module temperatures do not dictate so. For example, consider the situation where the ambient temperature sensor 150 provides an input to the control module 140 that an exterior temperature is sufficiently low (as a non-limiting example, 32° F. or less) to require increased engine warm-up times. Here, even though the vehicle speed is not sufficient and/or the various vehicle component temperature sensors described above would not indicate increased engine, cooling module, coolant, etc. temperatures requiring retraction or deployment of a conventional AGS system tied to vehicle speed and/or vehicle component temperature sensors, the control module 140 can be configured to fully or partially deploy the grille shade according to sensor-provided ambient temperature readings to aid in coolant temperature regulation and in reducing cold weather engine warm-up time.

Obvious modifications and variations are possible in light of the above teachings. For example, rather than the rollup style shade described above, the grille shade 110 could be provided in alternative configurations, for example in a folding “Roman shade” design while still minimizing packaging space required for the active grille shade assembly 102. Likewise, rather than driving the carrier 108, the motor 124 could be configured to directly or indirectly drive the lower drive shaft 126 to then drive the drive elements 120a, 120b. All such modifications and variations are within the scope of the appended claims when interpreted in accordance with the breadth to which they are fairly, legally and equitably entitled.

1. A grille shade assembly for a vehicle, comprising:
a deployable flexible grille shade;
one or more drive elements for translating the flexible grille shade between a deployed and a retracted position;
one or more support struts for supporting the flexible grille shade when translated to the deployed position, wherein the one or more support struts are substantially parallel to the one or more drive elements; and
a motor operatively connected to the one or more drive elements.

2. The assembly of claim 1, including a carrier carrying the deployable flexible grille shade and operatively connected to the one or more drive elements.

3. (canceled)

4. The assembly of claim 1, wherein one or more support struts are substantially vertically oriented.

5. The assembly of claim 1, further including one or more trolley slides configured for engaging a portion of the flexible grille shade and the one or more drive elements.

6. The assembly of claim 1, further including a lower drive shaft for engaging the one or more drive elements.

7. The assembly of claim 6, wherein the assembly is carried by an upper frame rail, a lower frame rail, and a pair of opposed side rails.

8. The assembly of claim 7, wherein the pair of opposed side rails are configured to slidingly receive at least a portion of the one or more drive elements, the one or more trolley slides, and the lower drive shaft in an interior channel thereof.

9. The assembly of claim 1, further including a controller operatively connected to the motor and to one or more sensors selected from one or more of an engine temperature sensor, a coolant temperature sensor, a vehicle-exterior ambient temperature sensor, a cooling module temperature sensor, and a vehicle speed sensor.

10. A vehicle including the assembly of claim 1.

11. A grille shade assembly for a vehicle, comprising:
a deployable flexible grille shade;
one or more drive elements for translating the flexible grille shade between a deployed and a retracted position;
at least two horizontally spaced support struts for supporting the flexible grille shade when translated to the deployed position; and
a motor operatively connected to the one or more drive elements.

12. The assembly of claim 11, further including a carrier carrying the deployable flexible grille shade and operatively connected to the one or more drive elements.

13. The assembly of claim 11, wherein the at least two support struts are substantially vertically oriented.

14. The assembly of claim 11, further including one or more trolley slides configured for engaging a portion of the flexible grille shade and the one or more drive elements.

15. The assembly of claim 11, further including a lower drive shaft for engaging the one or more drive elements.

16. The assembly of claim 15, wherein the assembly is carried by an upper frame rail, a lower frame rail, and a pair of opposed side rails.

17. The assembly of claim 16, wherein the pair of opposed side rails are configured to slidingly receive at least a portion of the one or more drive elements, the one or more trolley slides, and the lower drive shaft in an interior channel thereof.

18. The assembly of claim 11, further including a controller operatively connected to the motor and to one or more sensors selected from one or more of an engine temperature sensor, a coolant temperature sensor, a vehicle-exterior ambient temperature sensor, a cooling module temperature sensor, and a vehicle speed sensor.

19. (canceled)

20. A vehicle including the assembly of claim 11.
